(19) United States
(12) Patent Application Publication
(10) Pub. No.: US 2008/0211774 A1
(43) Pub. Date: Sep. 4, 2008

(54) CORDLESS MOUSE APPARATUS HAVING INTERNET PHONE BASED ON BLUETOOTH PROTOCOL, OPERATION METHOD THEREOF, AND COMMUNICATION SYSTEM HAVING INTERNET PHONE BASED ON BLUETOOTH PROTOCOL

(76) Inventor: Min Jae WOO, Seoul (KR)

Correspondence Address: IPLA P.A., 3580 WILSHIRE BLVD., 17TH FLOOR, LOS ANGELES, CA, 90010, US

(21) Appl. No.: 12/040,619

(22) Filed: Feb. 29, 2008

(30) Foreign Application Priority Data
Mar. 2, 2007 (KR) 10-2007-0020745
Mar. 9, 2007 (KR) 10-2007-0023296

(51) Int. Cl. G06F 3/033; H04B 7/00

(52) U.S. Cl. 345/166; 455/41.2

(57) ABSTRACT

A Bluetooth-based cordless mouse apparatus has a communication function of an internet phone and optionally further has a USB mass storage so as to enhance a user's convenience and improve voice quality. This apparatus provides several functions such as a wireless mouse, a wireless keypad, a USB mass storage, a wireless presenter, and a wired/wireless phone through a single Bluetooth protocol based device, and allows letter/number input in presentation. A wired/wireless phone-based terminal in a communication system has a Bluetooth-based wireless camera module and an image transmission function via an internet network or a public network to realize a remote security function. This system allows a user, who is out, to check inner conditions of a home by using a mobile phone or an internet-connected computer, thus realizing home monitoring using an embedded camera module.

### CROSS REFERENCES

Applicant claims foreign priority under Paris Convention and 35 U.S.C. §119 to Korean Patent Application No. 10-2007-0020745, filed March 2, and Korean Patent Application No. 10-2007-0023296, filed Mar. 9, 2007, each with the Korean Intellectual Property Office.

### BACKGROUND OF THE INVENTION

1. Field of the Invention

The present invention relates generally to an apparatus, a system and a method using Bluetooth, which is one of local area wireless communication standards. More particularly, the present invention relates to a Bluetooth-based cordless mouse having a communication function of an internet phone to enhance a user's convenience and improve voice quality, and a wired/wireless phone having a wireless camera module to offer an image transmission function and realize a remote security function.

2. Description of the Related Art

With a recent tendency in chipset technology for wireless terminals to minimization and one-chip, mobile terminals have also ensured durability and technical stability. However, mobile terminals are facing users' increasing demands such as a reduction in communication service charges. To meet such needs, many manufacturers have recently attempted to develop lower-priced communication systems, methods and goods. One of them is an internet phone.

On the other hand, with a remarkable growth of Bluetooth technology, this technology has been widely used for a variety of devices and products, such as a wireless headset for a mobile phone, a cordless mouse for a notebook computer, etc.

The current Bluetooth technology may, however, fail to simultaneously realize both of voice call and data communication using a single chipset. So, in a conventional art, several peripheral devices with different functions have been required for a single main device.

### SUMMARY OF THE INVENTION

The present invention provides a Bluetooth-based cordless mouse having a communication function of an internet phone and optionally further having a USB mass storage so as to enhance a user's convenience and improve voice quality.

Additionally, the present invention provides a communication system in which a wired/wireless phone-based terminal has a Bluetooth-based wireless camera module and an image transmission function via an internet network or a public network to realize a remote security function.

In one aspect of the present invention, a cordless mouse apparatus having an internet phone based on Bluetooth protocol, comprises a speaker and a microphone disposed on a front face and used for the call of the internet phone; an LCD disposed on the front face and used for the display of letters and numbers; a keypad disposed on the front face, allowing letter input, and having numerical buttons and volume up/down keys; control keys disposed on the front face and supporting functions of a presenter and a mouse; an optical mouse disposed on a rear face; a laser pointer switch disposed on one of side faces; a mode selection switch disposed on one of the side faces; page up/down switches disposed on one of the side faces and used for presentation; and a laser beam emission hole disposed on a top face and used for a laser pointer.

In this apparatus, the mode selection switch may allow recognizing one of desk, handy, phone, and camera modes.

In another aspect of the present invention, a cordless mouse apparatus having an internet phone based on Bluetooth protocol, comprises a main control unit connected to peripheral devices, creating a variety of control signals and data, and allowing A2DP/HSP/HID/VDP profiles of Bluetooth to be used in parallel; a Bluetooth RF module modulating audio/video/mouse/keypad data, which are transmitted to and received from the main control unit through a series interface, to Bluetooth protocol, and allowing a wireless connection with a PC; an audio codec connected to a microphone and a speaker, digitizing voice signals, and communicating with the main control unit; a keypad used for the input of letters and numbers; a mouse sensor performing a mouse pointing function, being one of an optical mouse sensor and a laser mouse sensor; a hall sensor used as a mouse pointing device in a handy mode and used as a four-way scroll input device in a desk mode; a camera sensor sending image data to the main control unit; and a mode selection switch allowing the main control unit to recognize a mode through a GPIO driver.

In this apparatus, the mode selection switch may allow the main control unit to recognize one of desk, handy, phone, and camera modes.

The apparatus may further comprise a mass storage equipped in the apparatus to store a variety of data; and a USB cable allowing the mass storage to be accessed as an external memory.

Also, the apparatus may further comprise a display module displaying a state and an operation mode of the apparatus and inputted letters and numbers.

In still another aspect of the present invention, an operation method of a cordless mouse apparatus having an internet phone based on Bluetooth protocol, comprises the steps of: selecting a mode wherein an A2DP/HSP mode is enabled when a mode selection switch is 1, wherein a camera mode is enabled when the mode selection switch is not 1, and wherein an HID mode always accesses an idle state; performing at least one idle state among the HID mode, the A2DP/HSP mode, and the camera mode wherein the HID mode coexists with the other modes or operates alone, and wherein the A2DP/HSP mode and the camera mode do not simultaneously operate; and determining whether there are user's data, including determining whether there is a motion of a mouse or a keypad, transmitting data to an HID profile processing unit when there is a motion of the mouse or the keypad, returning to the idle state otherwise, converting a current mode into an HSP mode and then sending or receiving data of a microphone and a speaker to or from an HSP profile processing unit when a user tries to send a call or receives a call, returning to the idle state otherwise, sending data to a VDP profile processing unit when a user selects the camera mode, and returning to the idle state otherwise.

In further another aspect of the present invention, a communication system having an internet phone based on Bluetooth protocol, comprises a modem connected to an Ethernet port in a home or an office to access an internet network; an inner computer located in the home or the office and coupled to the modem; a Bluetooth terminal making a wireless connection with the inner computer and having a camera module obtaining image data in the home or the office; and a mobile phone or an outer computer connected to the internet network and receiving the image data through the internet network.

In further another aspect of the present invention, a communication system having an internet phone based on Bluetooth protocol, comprises a modem connected to an Ethernet port in a home or an office to access an internet network; an inner computer located in the home or the office and coupled to the modem; a Bluetooth terminal making a wireless connection with the inner computer and having a camera module obtaining image data in the home or the office; and a mobile phone receiving the image data through a mobile base station and the internet network.

In further another aspect of the present invention, a communication system having an internet phone based on Bluetooth protocol, comprises a wired/wireless phone located in a home or an office and connected to a public network; a Bluetooth terminal making a wireless connection with the wired/wireless phone and having a camera module obtaining image data in the home or the office; and a mobile phone receiving the image data through a mobile base station and the public network.

The above-mentioned cordless mouse apparatus of the present invention not only provides several functions such as a wireless mouse, a wireless keypad, a USB mass storage, a wireless presenter, and a wired/wireless phone through a single Bluetooth protocol based device, but also allows letter/number input during presentation.

Additionally, the above-mentioned communication system of the present invention allows a user, who is out, to check inner conditions of a home by using a mobile phone or an internet-connected computer, thus realizing home monitoring using an embedded camera module.

### BRIEF DESCRIPTION OF THE DRAWINGS

FIG. 1 is a schematic view illustrating a network configuration of an internet phone service.

FIG. 2 is a perspective view illustrating a front appearance of an apparatus in accordance with an embodiment of the present invention.

FIG. 3 is a perspective view illustrating a rear appearance of an apparatus in accordance with an embodiment of the present invention.

FIG. 4 is a block diagram illustrating a cordless mouse apparatus using an internet phone based on Bluetooth protocol in accordance with an embodiment of the present invention.

FIG. 5 is a flow diagram illustrating an operation of a cordless mouse apparatus using an internet phone based on Bluetooth protocol in accordance with an embodiment of the present invention.

FIG. 6 is a schematic view illustrating a configuration of a Bluetooth protocol based internet phone and a related communication system in accordance with an embodiment of the present invention.

FIG. 7 is a schematic view illustrating a Bluetooth protocol based internet phone and a related communication system in accordance with a first embodiment of the present invention.

FIG. 8 is a schematic view illustrating a Bluetooth protocol based internet phone and a related communication system in accordance with a second embodiment of the present invention.

FIG. 9 is a schematic view illustrating a Bluetooth protocol based internet phone and a related communication system in accordance with a third embodiment of the present invention.

### DETAILED DESCRIPTION OF THE INVENTION

Exemplary, non-limiting embodiments of the present invention will now be described more fully hereinafter with reference to the accompanying drawings. This invention may, however, be embodied in many different forms and should not be construed as limited to the exemplary embodiments set forth herein. Rather, the disclosed embodiments are provided so that this disclosure will be thorough and complete, and will fully convey the scope of the invention to those skilled in the art. The principles and features of this invention may be employed in varied and numerous embodiments without departing from the scope of the invention.

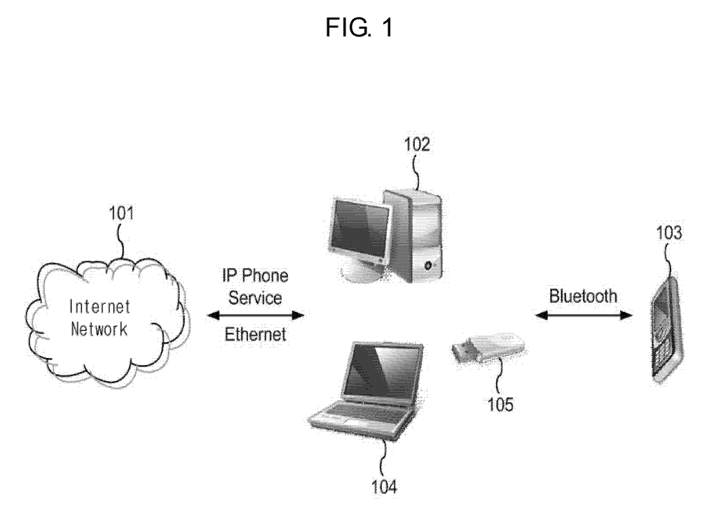

FIG. 1 is a schematic view illustrating a network configuration of an internet phone service. Referring to FIG. 1, a Bluetooth-enabled PC 102 or a Bluetooth-disabled PC 104 is connected to an internet network 101 through an Ethernet port in a home or an office. To access internet phone service sites, etc., an internet phone 103 makes a wireless connection with the Bluetooth-enabled PC 102 or a Bluetooth-disabled PC 104 through a Bluetooth USB dongle 105.

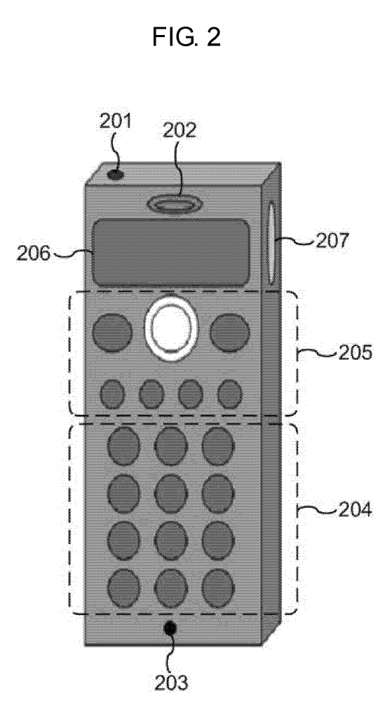

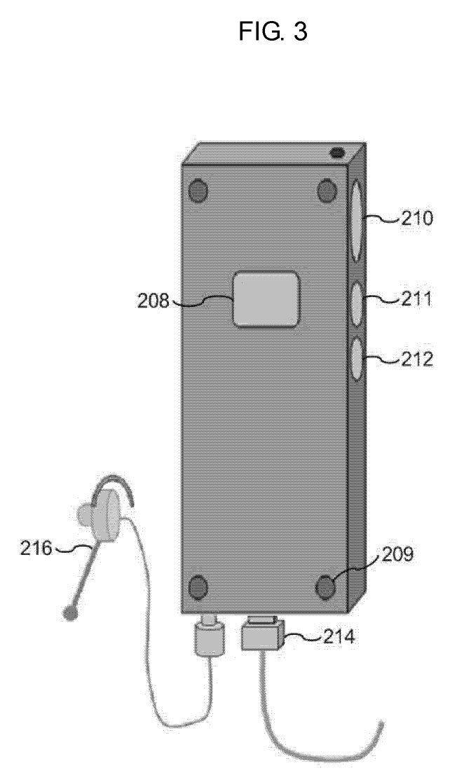

FIGS. 2 and 3 are perspective views respectively illustrating front and rear appearances of an apparatus in accordance with an embodiment of the present invention. The apparatus shown in FIGS. 2 and 3 is a composition device of a cordless mouse and an internet phone based on Bluetooth protocol. This apparatus includes, on its front face, a speaker 202 and a microphone 203 for the call of the internet phone, an LCD 206 for the display of letters and numbers, a keypad 204 allowing letter input and having numerical buttons and volume up/down keys, and control keys 205 supporting functions of a presenter and a mouse. The apparatus also includes an optical mouse 208 on its rear face, and a laser pointer switch 207 on its one side face. Additionally, the apparatus includes a mode selection switch 210 and page up/down switches 211, 212 for presentation on its another side face, and a laser beam emission hole 201 on its top face.

The apparatus with the above-discussed configuration can control the mouse and the keypad by means of Bluetooth chipset that supports a terminal interface based on Bluetooth HID profile. Furthermore, the apparatus can realize wireless communication by controlling an IP-based internet phone communication circuit through the extended MCU out of the chipset and transmitting voice signals based on Bluetooth protocol.

In addition, the apparatus can charge an embedded battery and realize a wired internet phone communication by connecting a battery charging circuit with the internet phone communication circuit through a USB port located on a bottom face thereof. Also, the apparatus can offer a function of a portable USB mass storage when a USB cable is connected to an embedded mass storage through the USB port.

Accordingly, the apparatus of the invention is an internet phone based on Bluetooth protocol and a cordless mouse using the internet phone. That is, the apparatus allows a Bluetooth based operation and an IP based internet phone service. Contrary to a conventional cordless mouse that does not allow inputting letters and numbers, the apparatus allows letter/number input through the keypad even during presentation by using the selection switch. Moreover, the apparatus provides an internet phone service using Bluetooth communication and USB adapter so as to simultaneously support wired and wireless phone calls.

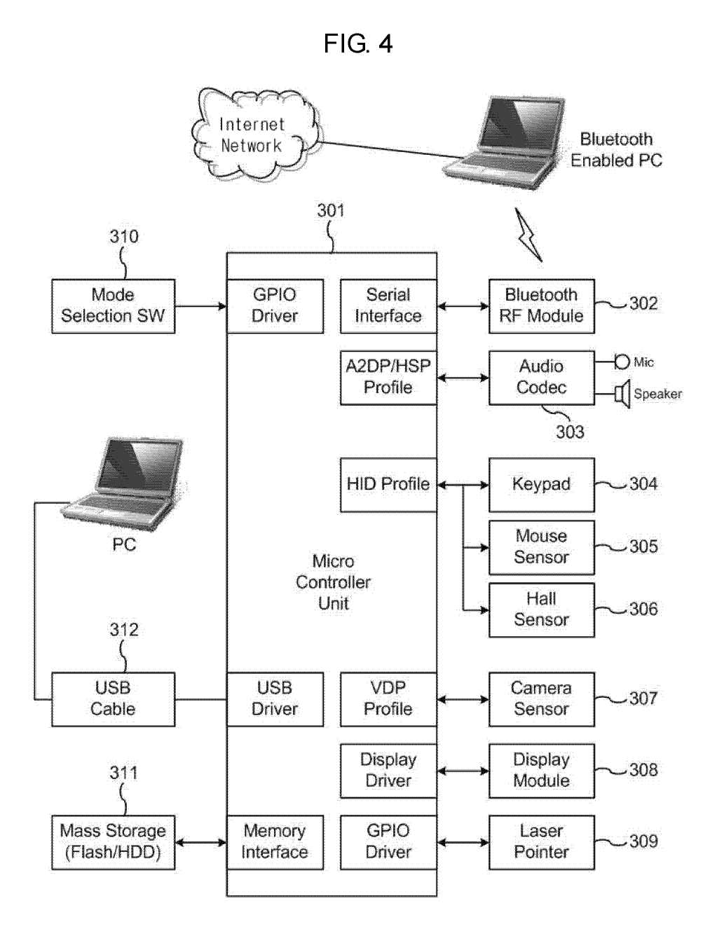

FIG. 4 is a block diagram illustrating a cordless mouse apparatus using an internet phone based on Bluetooth protocol in accordance with an embodiment of the present invention. Referring to FIG. 4, the apparatus includes a main control unit (MCU) 301 connected to peripheral devices. The MCU 301 creates a variety of control signals and data, and allows A2DP/HSP/HID/VDP profiles of Bluetooth to be used in parallel. The apparatus further includes a Bluetooth RF module 302 that modulates audio/video/mouse/keypad data, transmitted to and received from the MCU through a series interface, to Bluetooth protocol and allows a wireless connection with PC. Additionally, the apparatus includes an audio codec 303, a keypad 304, a mouse sensor 305, a hall sensor 306, a camera sensor 307, a display module 308, a laser pointer 309, a mode selection switch 310, a mass storage 311, and a USB cable 312.

The audio codec 303 connected to a microphone and a speaker digitizes voice signals and communicates with the MCU 301. And, the MCU 301 processes such data by using the A2DP/HSP profile and then communicates with the Bluetooth RF module 302.

The keypad 304 is a kind of key input device acting like a keyboard of a PC. The MCU 301 processes key input data using the HID profile and then communicates with the Bluetooth RF module 302. The mouse sensor 305 performs a mouse pointing function, and an optical mouse sensor or a laser mouse sensor is chiefly used therefor. The MCU 301 processes mouse data using the HID profile and then communicates with the Bluetooth RF module 302. The hall sensor 306 is used as a mouse pointing device in a handy mode, and used as a four-way scroll input device in a desk mode.

The camera sensor 307 sends image data to the MCU 301, which processes such image data using the VDP profile and then communicates with the Bluetooth RF module 302.

The display module 308, e.g. LCD, OLED, etc., serves as a user interface of the apparatus. The MCU 301 allows the display module 308 to display various data such as caller ID, battery information, and RF received signal strength through a display driver.

The laser pointer 309 is a peripheral device for presentation and is connected to the MCU 301 via a GPIO driver. The MCU 301 controls on/off of the laser pointer 309. The mass storage 311 is equipped in the apparatus to store a variety of data. The USB cable 312 allows a PC to access the mass storage 311 in the apparatus as an external memory. That is, data in the mass storage 311 are transmitted to a USB host, i.e., a PC through a USB driver in the MCU 301.

The mode selection switch 310 allows the MCU 301 to recognize one of desk, handy, phone, and camera modes through a GPIO driver. The desk mode is the same mode as a general mouse uses. In the desk mode, the mouse sensor 305 at the bottom of the apparatus performs a mouse pointing function, and the hall sensor 306 at the top of the apparatus performs a four-way scroll input function. The handy mode is a mode where the apparatus is raised with hands. In the handy mode, the mouse sensor 305 is disabled and the hall sensor 306 is used as a mouse pointing device. The phone mode is a mode where the apparatus is connected to a PC and used as an internet phone. The phone mode allows a voice call using the audio codec 303. In case of incoming call, the desk mode or the handy mode is automatically converted into the phone mode. The camera mode is a mode allowing an image monitoring using the camera sensor 307. In the camera mode, a PC or a mobile terminal located in a distant place is connected to the apparatus via internet and then remotely monitors image data inputted to the camera sensor 307.

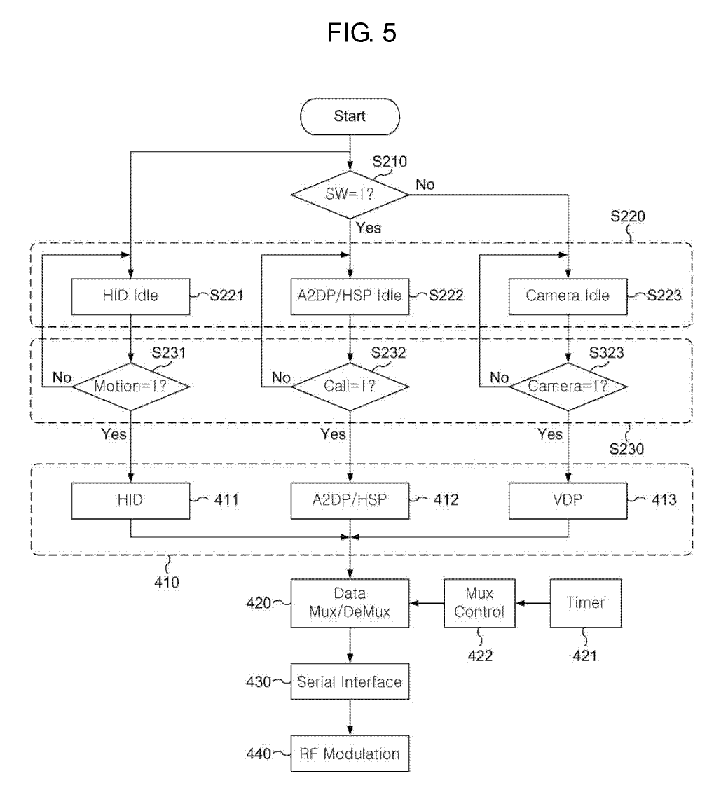

FIG. 5 is a flow diagram illustrating an operation of a cordless mouse apparatus using an internet phone based on Bluetooth protocol in accordance with an embodiment of the present invention. Referring to FIG. 5, in a step S210, a mode selection switch selects an A2DP/HSP mode or a camera mode. An HID mode always accesses an idle state regardless of the state of the switch. In the step S210, when the switch is 1, the A2DP/HSP mode is enabled, and when the switch is not 1, the camera mode is enabled.

In a step S220, the apparatus allows three idle states, namely, the HID mode, the A2DP/HSP mode, and the camera mode. Particularly, the HID mode (S221) may coexist with the other modes or operate alone. However, the A2DP/HSP mode (S222) and the camera mode (S223) can not simultaneously operate since they may cause overload to traffic. Such idle states can be modified by external interrupt and optionally set by a user through a button or a switch.

A next step S230 is a process that determines whether there are user's data. In a step S231, the MCU determines whether there is a motion of a mouse or a keypad, and if yes, data are transmitted to an HID profile processing unit. In a step S232, when a user tries to send a call or receives a call, the MCU converts a current mode into an HSP mode and then sends and receives data of a microphone and a speaker to and from an HSP profile processing unit. If a user attempts to listen to music, the MCU sends audio data from an A2DP profile processing unit to the speaker. In a step S233, when a user selects the camera mode, the MCU sends data to a VDP profile processing unit.

In FIG. 5, a Bluetooth profile block 410 is a program permanently stationed in the form of S/W code in a RAM of the MCU. The Bluetooth profile block 410 has an HID profile 411, an A2DP/HSP profile 412, and a VDP profile 413. The HID profile 411 is a Bluetooth standard profile that processes data created in the mouse, the keypad, etc. The A2DP profile 412 processes stereo audio data and the HSP profile 412 for hands-free processes voice data from the microphone to the speaker. The VDP profile 413 is a Bluetooth standard profile that distributes camera data.

If there are data of the mouse or the keypad in the step S231, such data is transmitted to the processing unit for the HID profile 411. If there is a call in the step S232, data of a microphone and a speaker are sent to or received from the processing unit for the A2DP/HSP profile 412. And, in case of music listening in the step S232, audio data are sent to the processing unit for the A2DP/HSP profile 412. If the camera mode is selected in the step S233, data are sent to the processing unit for the VDP profile 413.

A timer 421 is equipped in the MCU and generates standard clocks for controlling traffic amount. A Mux controller 422 regulates traffic of HID/A2DP/HSP data or HID/VDP data inputted into a Mux/DeMux 420, being based on the standard clocks of the timer 421. The regulation of traffic means regulating the amount of data carried on a Bluetooth packet frame. The Mux/DeMux 420 composes HID/A2DP/HSP/VDP data under the traffic regulation of the Mux controller 422.

Data composed by the Mux/DeMux 420 are carried on a communication line through a series interface 430. An RF modulator 440 modulates data inputted through the series interface 430 according to a Bluetooth method or demodulates RF signals transmitted from a host system.

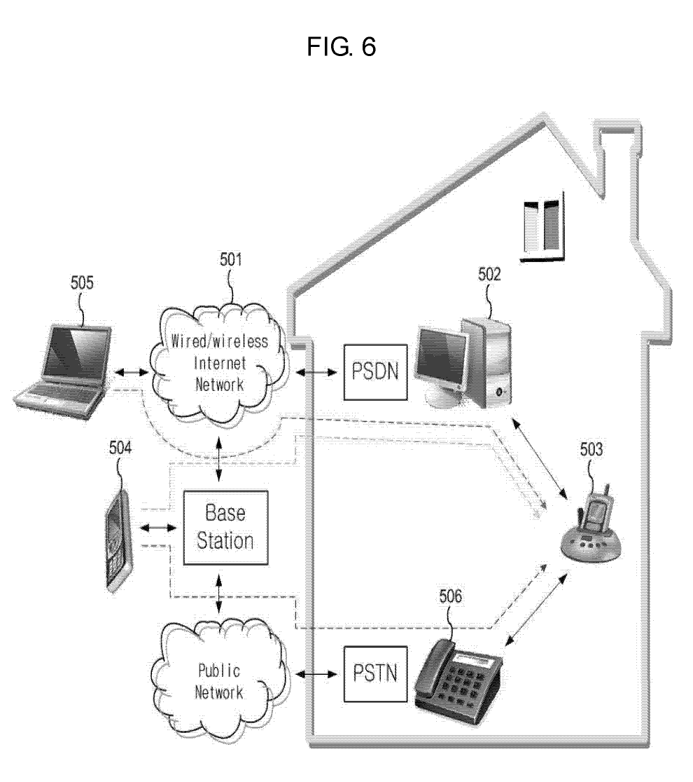

FIG. 6 is a schematic view illustrating a configuration of a Bluetooth protocol based internet phone and a related communication system in accordance with an embodiment of the present invention. FIG. 6 shows a configuration of a service that realizes a hands-free function and a home monitoring function using a Bluetooth headset coupled to a wired/wireless phone. In FIG. 6, a path of an outer computer 505, an internet network 501, an inner computer 502, and a Bluetooth terminal 503 realizes the home monitoring function through the headset coupled to the outer computer 505. Another path of a mobile phone 504, a mobile base station, the internet network 501, the inner computer 502, and the Bluetooth terminal 503 realizes the hands-free function and the home monitoring function through the headset coupled to the mobile phone 504. Still another path of the mobile phone 504, the mobile base station, a public network, a wired/wireless phone 506, and the Bluetooth terminal 503 transmits image data to the mobile phone 504 by using the home monitoring service based on the wired public network.

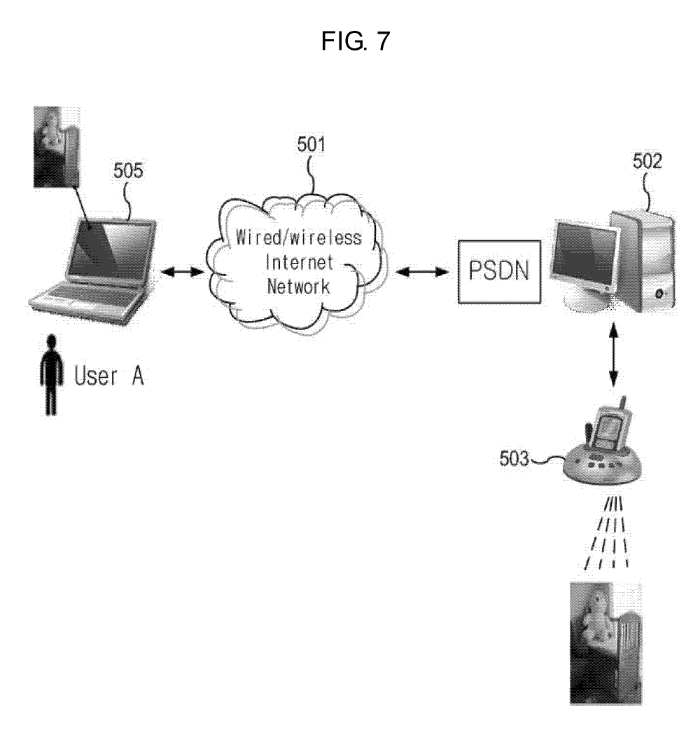

FIG. 7 is a schematic view illustrating a Bluetooth protocol based internet phone and a related communication system in accordance with a first embodiment of the present invention. FIG. 7 shows a configuration that realizes the home monitoring function through the headset coupled to the computer using the internet network. In FIG. 7, a modem is connected to the Ethernet port in a home or an office to access the internet network 501. Image data are obtained through a camera module equipped in the Bluetooth terminal 503 that makes a wireless connection with the inner computer 502 coupled to the modem. Such image data can be confirmed by the mobile phone 504 of a user who is out or the outer computer 505 connected to the internet network 501.

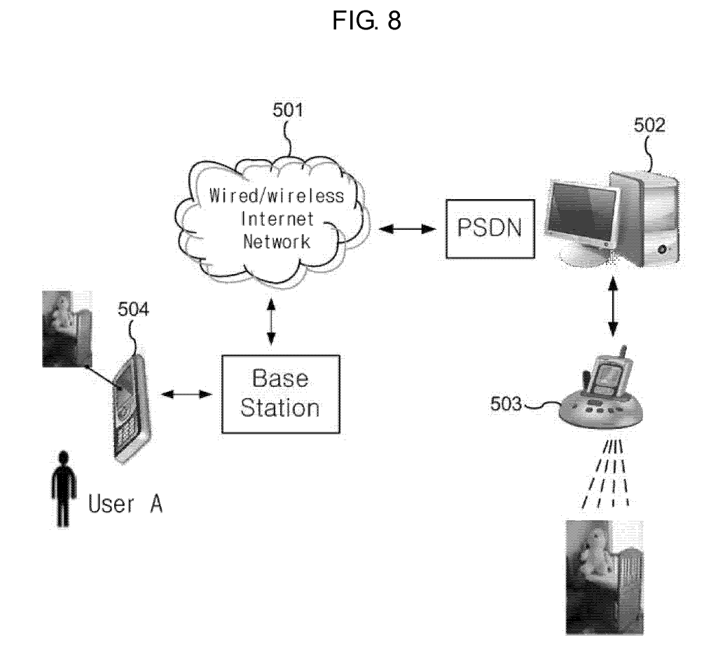

FIG. 8 is a schematic view illustrating a Bluetooth protocol based internet phone and a related communication system in accordance with a second embodiment of the present invention. FIG. 8 shows a configuration that realizes the hands-free function and the home monitoring function through the headset coupled to the phone. In FIG. 8, depending on the operation of the mobile phone 504 by a user who is out, image data are obtained through the camera module equipped in the Bluetooth terminal 503 that makes a wireless connection with the inner computer 502 coupled to the modem. Such image data are transmitted to the mobile phone 504 through the mobile base station, allowing a user to check inner conditions of a home.

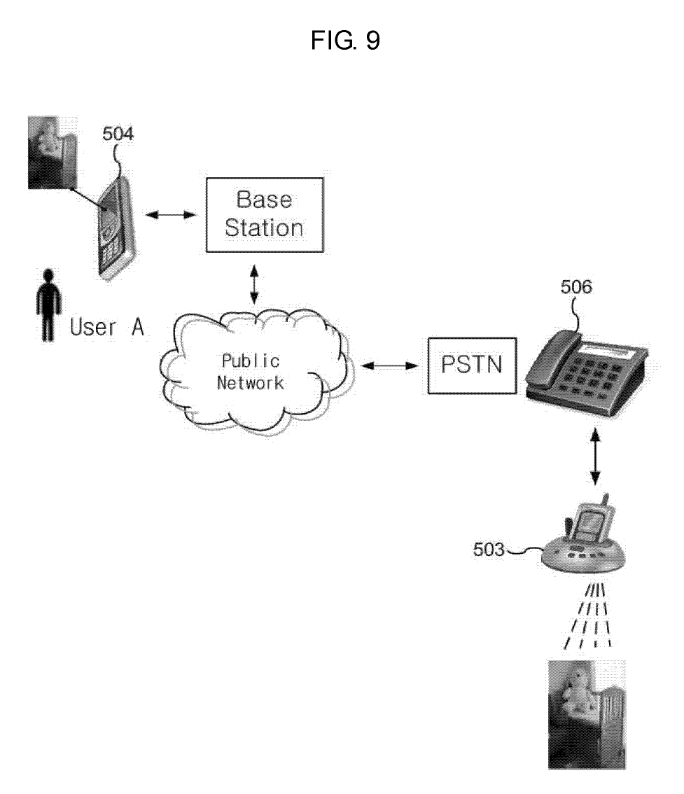

FIG. 9 is a schematic view illustrating a Bluetooth protocol based internet phone and a related communication system in accordance with a third embodiment of the present invention. FIG. 9 shows a configuration that realizes the home monitoring function using the public network. In FIG. 9, depending on the operation of the mobile phone 504 by a user who is out, image data are obtained through the camera module equipped in the Bluetooth terminal 503 that makes a wireless connection with the wired/wireless phone 506 in a home or an office. Such image data are transmitted to the mobile phone 504 through the public network and the mobile base station, allowing a user to check inner conditions of a home.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A cordless mouse apparatus having an internet phone based on Bluetooth protocol, said apparatus comprising:
a speaker and a microphone disposed on a front face and used for the call of the internet phone;
an LCD disposed on the front face and used for the display of letters and numbers;
a keypad disposed on the front face, allowing letter input, and having numerical buttons and volume up/down keys;
control keys disposed on the front face and supporting functions of a presenter and a mouse;
an optical mouse disposed on a rear face;
a laser pointer switch disposed on one of side faces;
a mode selection switch disposed on one of the side faces;
page up/down switches disposed on one of the side faces and used for presentation; and
a laser beam emission hole disposed on a top face and used for a laser pointer.

2. The apparatus of claim 1, wherein the mode selection switch allows recognizing one of desk, handy, phone, and camera modes.

3. A cordless mouse apparatus having an internet phone based on Bluetooth protocol, said apparatus comprising:
a main control unit connected to peripheral devices, creating a variety of control signals and data, and allowing A2DP/HSP/HID/VDP profiles of Bluetooth to be used in parallel;
a Bluetooth RF module modulating audio/video/mouse/keypad data, which are transmitted to and received from the main control unit through a series interface, to Bluetooth protocol, and allowing a wireless connection with a PC;
an audio codec connected to a microphone and a speaker, digitizing voice signals, and communicating with the main control unit;
a keypad used for the input of letters and numbers;
a mouse sensor performing a mouse pointing function, being one of an optical mouse sensor and a laser mouse sensor;
a hall sensor used as a mouse pointing device in a handy mode and used as a four-way scroll input device in a desk mode;
a camera sensor sending image data to the main control unit; and
a mode selection switch allowing the main control unit to recognize a mode through a GPIO driver.

4. The apparatus of claim 3, wherein the mode selection switch allows the main control unit to recognize one of desk, handy, phone, and camera modes.

5. The apparatus of claim 3, further comprising:
a mass storage equipped in the apparatus to store a variety of data; and
a USB cable allowing the mass storage to be accessed as an external memory.

6. The apparatus of claim 3, further comprising:
a display module displaying a state and an operation mode of the apparatus and inputted letters and numbers.

7. An operation method of a cordless mouse apparatus having an internet phone based on Bluetooth protocol, said method comprising the steps of:
selecting a mode wherein an A2DP/HSP mode is enabled when a mode selection switch is 1, wherein a camera mode is enabled when the mode selection switch is not 1, and wherein an HID mode always accesses an idle state;
performing at least one idle state among the HID mode, the A2DP/HSP mode, and the camera mode wherein the HID mode coexists with the other modes or operates alone, and wherein the A2DP/HSP mode and the camera mode do not simultaneously operate; and
determining whether there are user's data, including determining whether there is a motion of a mouse or a keypad, transmitting data to an HID profile processing unit when there is a motion of the mouse or the keypad, returning to the idle state otherwise, converting a current mode into an HSP mode and then sending or receiving data of a microphone and a speaker to or from an HSP profile processing unit when a user tries to send a call or receives a call, returning to the idle state otherwise, sending data to a VDP profile processing unit when a user selects the camera mode, and returning to the idle state otherwise.
